(19) United States
(12) Patent Application Publication
(10) Pub. No.: US 2010/0182438 A1
(43) Pub. Date: Jul. 22, 2010

(54) DYNAMIC USER INTERFACE FOR REMOTE CONTROL OF CAMERA

(76) Inventor: Soiba Mohammed, Sunnyvale, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/356,494

(22) Filed: Jan. 20, 2009

(51) Int. Cl. H04N 5/225; G06F 17/30

(52) U.S. Cl. 348/207.11; 348/E05.024; 707/E17.127

(57) ABSTRACT

A digital camera sends an XML document to a client application executing on a computer that is remote from the digital camera. The XML document describes a physical user interface of the digital camera. Based on the XML document received from the digital camera, the client application renders and displays a visual depiction of the digital camera's user interface. A user of the client application can remotely control the digital camera from the client application by interacting with the user interface elements shown in the visual depiction. User activation of controls shown in the visual depiction causes the digital camera to perform the same operations as the digital camera would perform if the user had actually activated the corresponding physical controls on the digital camera itself. The client application is capable of receiving different XML documents from different camera models, and rendering different interfaces based on those different XML documents.

### FIELD OF THE INVENTION

The invention relates to cameras, and more specifically, to systems and techniques for dynamically generating a user interface for the remote control of a camera.

### BACKGROUND

Digital cameras are capable of taking photographs and storing images of the subjects of those photographs in digital form. Most digital cameras come equipped with a physical user interface that includes multiple physical buttons and/or other physical controls. For example, a typical digital camera's user interface may include an ON/OFF switch that controls whether the camera is currently powered; a “snap” button which, when pressed, causes the camera to take a photograph of whatever is currently visible through the camera's lens; and a liquid crystal display (LCD) screen that constantly displays a digital image of whatever is currently visible through the camera's lens, thereby acting as a viewfinder.

Some digital cameras can receive commands from a human user via remote control. In some cases, a digital camera can be remotely controlled via a computer program of some kind. Under such circumstances, a user enters a command into a computer program that is executing on a computer that is remote from the digital camera. In response to the user's entry of the command, the computer program causes a corresponding signal to be sent (either wirelessly or via guided media) to the digital camera. The digital camera receives the signal and performs an action that corresponds to the user-entered command—all without the user ever actually needing to touch the digital camera.

However, the computer program that is used to control a particular model of digital camera typically will be designed specifically for that particular model of digital camera and not for any other model of digital camera. As a result, each remotely controllable digital camera typically needs to be shipped with computer software that is custom designed to control that camera's particular model. A manufacturer of multiple models of digital cameras therefore might need to design and produce different computer software for different models of digital cameras that the manufacturer produces. This is especially likely to be the case when the manufacturer comes out with a new model of digital camera that has features that the manufacturer's previous digital camera models did not have; software for the previous digital camera models is unlikely to support the new model's new features. All of this increases the manufacturer's expense of producing and selling remotely controllable digital cameras.

Additionally, because different digital camera manufacturers are in competition with each other, and because these manufacturers rarely have any incentive to collaborate with each other, different manufacturers are likely to produce very different software products even for very similar models of digital cameras if those models are produced by different manufacturers. Under such circumstances, if a particular user desires to use two different manufacturers' digital cameras in conjunction with his computer (e.g., to remotely control both cameras), then the user may be forced to install two different software programs on his computer. The user additionally may be required to learn how to use two very different software programs. All of this can irritate the user.

Existing software programs through which users can remotely control digital cameras are largely unrelated, visually, to the actual appearance of those digital camera's physical user interfaces. Although a software program might have some textual menu option which, when selected by the user, causes the digital camera to perform some corresponding action or function, the textual menu option might not correspond to any one particular physical control of the digital camera's physical user interface. It might not be immediately apparent, to a user who has only operated a particular digital camera using that camera's physical user interface, which textual menu option(s) the user ought to select in order to cause the digital camera to perform a desired action. This, also, can be a frustrating experience for the user.

### SUMMARY

Techniques and systems for dynamically generating a user interface for the remote control of a camera are disclosed. In one embodiment of the invention, a digital camera stores an Extensible Markup Language (XML) document that describes one or more elements of the digital camera's physical user interface. For example, the XML document may describe one or more physical controls that can be physically activated by the camera's user in order to cause the digital camera to perform functions that are associated with those controls. The digital camera sends the document to a remote computer with which the digital camera communicates through a wired or wireless connection. A client application executes on the remote computer. The client application receives the XML document from the digital camera and renders a visual image of each user interface element that is described by the XML document. In one embodiment of the invention, the client application renders each user interface element in a way such that the appearance of the user interface element in the visual image duplicates the appearance of the corresponding physical user interface element on the actual digital camera. The client application then displays the rendered digital camera user interface image to a user of the computer.

In one embodiment of the invention, the client application receives commands from the computer's user via the user's interaction with the user interface elements in the displayed visual user interface. In one embodiment of the invention, as the user interacts with the user interface elements in the displayed visual user interface, the client application sends, to the remote digital camera, signals that indicate which of the displayed visual user interface elements the user has interacted with. The digital camera receives these signals. In response to receiving a signal that indicates that the user interacted with a particular user interface element in the visual user interface displayed by the client application, the digital camera performs the same function that the digital camera would have performed if the user had actually interacted in the same way with the actual corresponding physical user interface element on the digital camera's physical user interface. Thus, a user can interact with the user interface displayed by the client application in the same manner that the user would interact with the camera's physical user interface in order to cause the camera to perform the same operations that the camera would have performed if the user had actually interacted with the camera's physical user interface instead.

Beneficially, in one embodiment of the invention, the client application is designed in a manner such that the client application can render any number of different visual user interfaces based on any number of different XML documents that describe those different visual user interfaces. Consequently, different models of digital cameras can be made to interact with the same client application, and such different models of digital cameras can all be remotely controlled via the same client application despite that fact that those different models of digital cameras might have vastly different user interfaces and/or functions. Each different model of digital camera may store a different XML document that describes that particular digital camera model's physical user interface. It is therefore unnecessary to create a new custom client application for each different model of remotely controllable digital camera.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is a block diagram that illustrates an example of a system in which a digital camera can be remotely controlled, according to an embodiment of the invention;

FIG. 2 is a diagram that illustrates an example of the sequence of message exchanges in which a client application and a digital camera may engage in order to communicate and generate an interactive visual depiction of that digital camera's user interface, according to an embodiment of the invention;

FIG. 3 is a block diagram that illustrates various functions provided by a web services client, which may execute on a computer, and various services provided by a web services server, which may execute on a digital camera, according to an embodiment of the invention;

FIG. 4 is a block diagram that illustrates an example of the functional modules that are provided by the hardware of a digital camera, according to an embodiment of the invention; and

FIG. 5 is a block diagram that depicts a device upon which an embodiment of the invention may be at least partially implemented.

### DETAILED DESCRIPTION

In the following description, for the purposes of explanation, specific details are set forth in order to provide a thorough understanding of the invention. However, it will be apparent that the invention may be practiced without these specific details. In some instances, well-known structures and devices are depicted in block diagram form in order to avoid unnecessarily obscuring the invention.

### Overview

A Web Services-based technique is employed to generate, dynamically, from a single client application, a user interface for any camera. The Web Services-based technique uses XML to describe the user interface and to allow the client application to generate a user interface specific to a particular camera. All of the functionality of the camera is mapped on the client application such that selecting a button in the user interface activates the functionality associated with that button on the camera.

### Example System

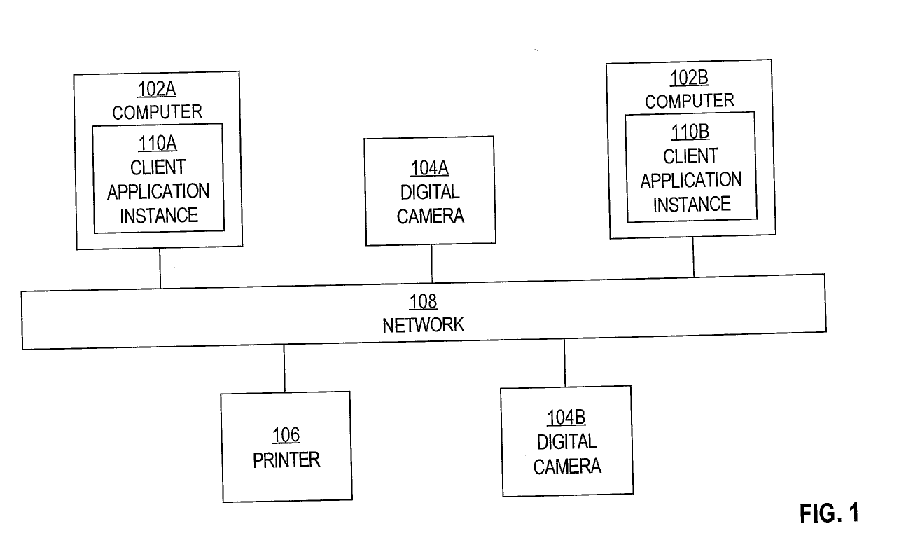

FIG. 1 is a block diagram that illustrates an example of a system 100 in which a digital camera can be remotely controlled, according to an embodiment of the invention. System 100 includes computers 102A and 102B. Each of computers 102A and 102B has a display (e.g., an LCD monitor) communicatively coupled with that computer. System 100 also includes digital cameras 104A and 104B. In one embodiment of the invention, digital cameras 104A and 104B are different models of digital camera. In one embodiment of the invention, digital cameras 104A and 104B are manufactured and sold by different business organizations. System 100 further includes printer 106 and network 108. In system 100, computers 102A-B, digital cameras 104A-B, and printer 106 are all communicatively coupled to network 108. Because these components are communicatively coupled to network 108, these components can communicate with each other by sending signals and messages to each other over network 108 using a suite of network communication protocols. The components which are communicatively coupled to network 108 may be communicatively coupled either by wired (e.g., Ethernet) or wireless (e.g., IEEE 802.11) communication interfaces. Network 108 itself may include one or more local area networks (LANs), wide area networks (WANs), and/or the Internet itself. Communication protocols such as Transmission Control Protocol (TCP) and/or Internet Protocol (IP) may be used to transmit and receive messages over network 108. Although the components in system 100 are shown as being communicatively coupled via network 108, alternatively inventions may involve various components being communicatively coupled together in various different configurations via any wired or wireless communication links.

In one embodiment of the invention, instances 110A and 110B of a client application execute on each of computers 102A and 102B. Thus, instances 110A and 110B are separately executing instances of the same software code. The client application is a computer program that receives, over network 108, from a digital camera such as either of digital cameras 104A-B, an XML document that describes a physical user interface of that digital camera. Upon receiving such an XML document, the client application renders, on the display of the computer upon which the client application is executing, a visual and interactive depiction of the user interface that the XML document describes. A user of the client application can interact with the controls depicted in the visual user interface in order to cause the client application to send messages over network 108 to the digital camera from which the client application received the XML document. These messages identify the controls with which the user interacted and/or the functions that the digital camera should perform in response to the user's interaction with those controls. In response to receiving these messages, the digital camera performs the same functions that the digital camera would have performed if the user had interacted with the same controls via the camera's physical user interface (rather than the corresponding visual user interface controls depicted by the client application, with which the user actually interacted).

Given that digital cameras 104A and 104B may be different models of digital camera, which may have significantly different physical user interfaces, controls, and functionality, the user interface-describing XML document that digital camera 104A locally stores may be different from the user interface-describing XML document that digital camera 104B locally stores. Nevertheless, each of client application instances 110A-B is capable of dynamically rendering a potentially different visual user interface from either of the digital cameras' XML documents. Therefore, digital camera 104A may send a first XML document, which describes a first user interface (of digital camera 104A), to client application 110A, and client application 110A may render and display a visual depiction of the first user interface. Later, digital camera 104B may send a second XML document, which describes a second user interface (of digital camera 104B), to client application 110A, and client application 110A may render and display a visual depiction of the second user interface.

### Example XML Schema

As is discussed above, in one embodiment of the invention, digital cameras 104A-B communicate descriptions of their physical user interfaces to client application instances 110A-B using Web Services. Web Services solutions are based on the premise that a set of operations can be defined that allow a client application and a server application to execute commands on each other. The operations are represented as XML messages carried within Simple Object Access Protocol (“SOAP”) packets, which may be encapsulated within one or more TCP and/or IP packets for transport over network 108. The structure and content of the XML messages, which correspond to operations, are defined in a schema. The schema defines the syntax and structure of each operation. The collection of operations defined in a schema constitutes a Web Service. Any application or device that implements the schema is able to provide the Web Service as either a client or a server.

An example of a schema is shown below in Table 1. The example illustrates the definition of an element named “CameraUserInterface,” which contains three elements of type “Button.” One of these elements represents an “ON” button. Another of these elements represents a “ZoomIn” button. Yet another of these elements represents a “ZoomOut” button. Each of the “Button” elements comprises sub-elements named “Xcoord,” “Ycoord,” “ButtonWidth,” “ButtonHeight,” and “ButtonShape.” Additionally, the schema defines a set of operations that include an operation called “GetUserInterfaceRequest” and an operation called “GetUserInterfaceResponse.” These operations are defined such that each response message will contain a “CameraUserInterface” element. Thus, in one embodiment of the invention, each user interface-describing XML document and each request and response XML message conform to the same schema.

TABLE 1
EXAMPLE XML SCHEMA

```
<definitions xmlns=“http://schemas.xmlsoap.org/wsdl/”
        xmlns:nscn=“http://schemas.ricoh.com/windows/2005/01/wdp/
        camera”
        xmlns:soap=“http://schemas.xmlsoap.org/wsdl/soap12/”
        xmlns:http=“http://schemas.xmlsoap.org/wsdl/http/”
        xmlns:xs=“http://www.w3.org/2001/XMLSchema”
        xmlns:soapenc=“http://schemas.xmlsoap.org/soap/encoding/”
        xmlns:mime=“http://schemas.xmlsoap.org/wsdl/mime/”
        targetNamespace=“http://schemas.microsoft.com/windows/2005/
        01/wdp/scan”>
  <types>
  <xs:element name”Button” type=”ButtonType”>
  <xs:complexType name=”ButtonType>
    <xs:sequence>
      <xs:element name=”Xcoord” minOccors=0>
        <xs:complexType>
          <xs:simpleContent>
            <xs:attribute ref=”MustHonor”>
          </xs:simpleType>
        </xs:complexType>
      </xs:element>
      <xs:element name=”Ycoord” minOccors=0>
        <xs:complexType>
          <xs:simpleContent>
            <xs:attribute ref=”MustHonor”>
          </xs:simpleType>
        </xs:complexType>
      </xs:element>
      <xs:element name=”ButtonWidth” minOccors=0>
        <xs:complexType>
          <xs:simpleContent>
            <xs:attribute ref=”MustHonor”>
          </xs:simpleType>
        </xs:complexType>
      </xs:element>
      <xs:element name=”ButtonHeight” minOccors=0>
        <xs:complexType>
          <xs:simpleContent>
            <xs:attribute ref=”MustHonor”>
          </xs:simpleType>
        </xs:complexType>
      </xs:element>
      <xs:element name=”ButtonShape” minOccors=0>
        <xs:complexType>
          <xs:simpleContent>
            <xs:attribute ref=”MustHonor”>
          </xs:simpleType>
        </xs:complexType>
      </xs:element>
    </xs:sequence>
  </xs:complexType>
  <xs:element name=”CameraUserInterface”
  type=”CameraUserInterfaceType”>
  <xs:complexType name=“CameraUserInterfaceType”>
    <xs:sequence>
      <xs:complexType name=”OnButton”>
        <xs:sequence>
          <xs:element ref=“Button”/>
        </xs:sequence>
      </xs:complexType>
      <xs:complexType name=”ZoomInButton”>
        <xs:sequence>
          <xs:element ref=“Button”/>
        </xs:sequence>
      </xs:complexType>
      <xs:complexType name=”ZoomOutButton”>
        <xs:sequence>
          <xs:element ref=“Button”/>
        </xs:sequence>
      </xs:complexType>
    </xs:sequence>
  </xs:complexType>
  </types>
  <message name=“GetUserInterfaceRequest”>
  </message>
  <message name=“GetUserInterfaceResponse”>
    <part name=“UserInterfaceInfo”
    element=“nscn:CameraUserInterface”/>
  </message>
<portType name=“CameraPortType”>
    <operation name=“GetUserInterface”>
        <input message=“nscn: GetUserInterfaceRequest ”/>
        <output message=“nscn: GetUserInterfaceResponse ”/>
    </operation>
  </portType>
  <binding name=“CameraServiceBinding”
  type=“nscn:CameraPortType”>
    <soap:binding style=“document”
    transport=“http://schemas.xmlsoap.org/soap/http”/>
    <operation name=“ GetUserInterface ”>
        <soap:operation
soapAction=“http://schemas.ricoh.com/windows/2005/01/wdp/camera/
GetUserInterface”
soapActionRequired=“true” style=“document”/>
        <input>
          <soap:body use=“encoded”
namespace=“http:schemas.microsoft.com/windows/2005/01/wdp/camera”
encodingStyle=“http://www.w3.org/2001/12/soap-encoding” />
        </input>
      <output>
        <soap:body use=“encoded”
namespace=“http:schemas.microsoft.com/windows/2005/01/wdp/camera”
encodingStyle=“http://www.w3.org/2001/12/soap-encoding” />
      </output>
    </operation>
</binding>
  <service name=“CameraService”>
    <port name=“CameraPortType”
    binding=“nscn:CameraServiceBinding”>
      <soap:address location=“http://localhost/CameraService/”/>
    </port>
  </service>
</definitions>
```

### Example User Interface Request Message

In one embodiment of the invention, a client application, such as one or client application instances 110A-B, executing on a computer, such as one of computers 102A-B, sends a request over network 108 to a digital camera, such as one of digital cameras 104A-B. The request is a “GetUserInterfaceRequest” XML document that conforms to the structure of that type of message as set forth in the schema discussed above. In one embodiment of the invention, the request message that the client application sends to the digital camera is a packet that contains an XML document in which the “Body” has a single empty element that specifies that the message is a “GetUserInterfaceRequest.” An example of a user interface request message is set forth in Table 2 below.

TABLE 2
EXAMPLE USER INTERFACE REQUEST MESSAGE

```
<?xml version=“1.0” encoding=“utf-8”?>
<soap:Envelope
    xmlns:soap=“http://www.w3.org/2003/05/soap-envelope”
    xmlns:wsdp=“http://schemas.xmlsoap.org/ws/2004/08/devprof”
    xmlns:wsa=“http://schemas.xmlsoap.org/ws/2003/03/addressing”
    xmlns:nscn=“http://schemas.ricoh.com/windows/2005/01/wdp/
    camera”>
    soap:encodingStyle=‘http://www.w3.org/2002/12/soap-encoding’ >
  <soap:Header>
    <wsa:To>uuid:CameraDeviceUUID</wsa:To>
    <wsdp:ServiceId>uri:IdofThisService</wsdp:ServiceId>
    <wsa:Action>http://schemas.ricoh.com/windows/2005/01/
    wdp/camera/GetUserInterface
  </wsa:Action>
    <wsa:MessageID>uuid:UniqueMsgId</wsa:MessageID>
  </soap:Header>
  <soap:Body>
    <nscn: GetUserInterfaceRequest >
    </nscn: GetUserInterfaceRequest >
  </soap:Body>
</soap:Envelope>
```

### Example User Interface Response Message

According to one embodiment of the invention, in response to receiving a “GetUserInterfaceRequest” XML document from a client application instance, a digital camera, such as one of digital cameras 104A-B, responds with a “GetUserInterfaceResponse” XML document that conforms to the structure of that type of message as set forth in the schema discussed above. The “GetUserInterfaceResponse” XML document specifies information that the requesting client application instance needs in order to generate, on the display of the computer on which the client application instance executes, an interactive visual depiction of the digital camera's physical user interface. The digital camera locally stores this information and uses this information to prepare the “GetUserInterfaceResponse” XML document that the digital camera will send to the client application. For example, if the digital camera's physical user interface includes three buttons, then the “GetUserInterfaceResponseMessage” XML document will contain a separate element for each of the three buttons. Each such element conforms to the syntax set forth in the schema discussed above.

An example of a user interface response message, which a digital camera would send to a client application in response to a user interface request message, is shown below in Table 3. The user interface response message is a “GetUserInterfaceResponse” XML document. The XML document has a “Body” that contains a “GetUserInterfaceResponse” element, thereby identifying the XML document as being a user interface response message. The “GetUserInterfaceResponse” element contains a “CameraUserInterface” element which specifies the dimensions, shapes, and locations of three buttons: an “ON” button, a “ZoomIn” button, and a “ZoomOut” button. The characteristics and attributes of each of these buttons is specified in a separate sub-element for each of those buttons. Additionally, each sub-element that corresponds to a button specifies an identifier that the client application later uses to identify, to the digital camera, the buttons in the visual, virtual user interface with which the user has interacted. Knowing the identity of a button with which the user has interacted in the visual user interface, the digital camera can perform the appropriate corresponding operation that is associated with that button. Although the example shown in Table 3 describes the characteristics and attributes of only three buttons, alternative user interface response messages may specified additional and/or different controls, some of which might be buttons, and some of which might be other kinds of controls (e.g., dials, switches, screens, joysticks, etc.). For example, an alternative user interface might additionally include a sub-element that describes the characteristics and attributes (e.g., the location and size) of an LCD display of a digital camera.

TABLE 3
EXAMPLE USER INTERFACE RESPONSE MESSAGE

```
<?xml version=“1.0” encoding=“utf-8”?>
<soap:Envelope
    xmlns:soap=“http://www.w3.org/2003/05/soap-envelope”
    xmlns:wsdp=“http://schemas.xmlsoap.org/ws/2004/08/devprof”
    xmlns:wsa=“http://schemas.xmlsoap.org/ws/2003/03/addressing”
    xmlns:nscn=“http://schemas.ricoh.com/windows/2005/01/wdp/
    camera”>
    soap:encodingStyle=‘http://www.w3.org/2002/12/soap-encoding’ >
  <soap:Header>
    <wsa:To>
      http://schemas.xmlsoap.org/ws/2003/03/addressing/role/anonymous
    </wsa:To>
    <wsa:Action>
      http://schemas.ricoh.com/windows/2005/01/wdp/camera/
      GetUserInterfaceResponse
  </wsa:Action>
    <wsa:MessageID>uuid:UniqueMsgId</wsa:MessageID>
    <wsa:RelatesTo>uuid:MsgIdOfTheGetUserInterfaceRequest
    </wsa:RelatesTo>
  </soap:Header>
  <soap:Body>
    <nscn:GetUserInterfaceResponse>
      <nscn:CameraUserInterface>
        <nscn:OnButton>
          <nscn:Button>
            <nscn:Identifier> 1 </nscn:Identifier>
            <nscn:Xcoord> 5 </nscn:Xcoord>
            <nscn:Ycoord> 7 </nscn:Ycoord>
            <nscn:ButtonWidth> 10 </nscn:ButtonWidth>
            <nscn:ButtonHeight> 10 </nscn:ButtonHeight>
            <nscn:ButtonShape> circle </nscn:ButtonShape>
        </nscn:OnButton>
        <nscn:ZoomInButton>
          <nscn:Button>
            <nscn:Identifier> 2 </nscn:Identifier>
            <nscn:Xcoord> 16 </nscn:Xcoord>
            <nscn:Ycoord> 24 </nscn:Ycoord>
            <nscn:ButtonWidth> 9 </nscn:ButtonWidth>
            <nscn:ButtonHeight> 9 </nscn:ButtonHeight>
            <nscn:ButtonShape> diamond </nscn:ButtonShape>
        </nscn:ZoomInButton>
        <nscn:ZoomOutButton>
          <nscn:Button>
            <nscn:Identifier> 3 </nscn:Identifier>
            <nscn:Xcoord> 20 </nscn:Xcoord>
            <nscn:Ycoord> 24 </nscn:Ycoord>
            <nscn:ButtonWidth> 9 </nscn:ButtonWidth>
            <nscn:ButtonHeight> 9 </nscn:ButtonHeight>
            <nscn:ButtonShape> diamond </nscn:ButtonShape>
        </nscn:ZoomOutButton>
      </nscn:CameraUserInterface>
    </nscn:GetUserInterfaceResponse>
  </soap:Body>
</soap:Envelope>
```

### Dynamically Generating the Visual User Interface

According to one embodiment of the invention, the client application that sent a user interface request message to the digital camera receives, from the digital camera, a user interface response message (e.g., of the kind shown by way of example in Table 3 above) over network 108 in reply. Based on the information in the user interface response message, the client application dynamically generates and displays a visual depiction of the digital camera's physical user interface as described by the XML elements in the user interface response message. Using the x and y coordinates specified in each of the “button” sub-elements (e.g., “On,” “ZoomIn” and “ZoomOut,”), the client application determines where in the visual user interface each of the corresponding buttons should be placed when drawn. Using the size attributes specified in each of the “button” sub-elements, the client application determines how large to draw each of the corresponding buttons in the visual user interface.

### Responding to User Interaction with Visual Controls

Additionally, as is discussed above, each element that corresponds to a control (such as a button) may be associated with a unique (among controls) identifier that is specified in that control's XML sub-element. In one embodiment of the invention, when a user interacts with a particular control in the visual user interface (e.g., by mouse-clicking on that control's depiction) displayed on the computer, the client application sends the particular control's associated identifier over network 108 to the digital camera. The digital camera then uses this identifier to determine the control with which the user interacted. The digital camera responsively performs the same operations that the digital camera would have performed had the user similarly interacted with the control's physical counterpart on the actual digital camera. For example, if the “Zoom Out” button is associated with an identifier of “3,” then, in response to a user's clicking on the “Zoom Out” button in the visual user interface, the client application may send, to the digital camera, a message that indicates that the control associated with “3” was pushed. Upon receiving this information, the digital camera may responsively adjust its lens to zoom out from the subject on which the digital camera is currently focused, just as the digital camera would have if the user had physically pushed the physical “Zoom Out” button on the digital camera itself.

### Example Client-Camera Message Exchange Sequence

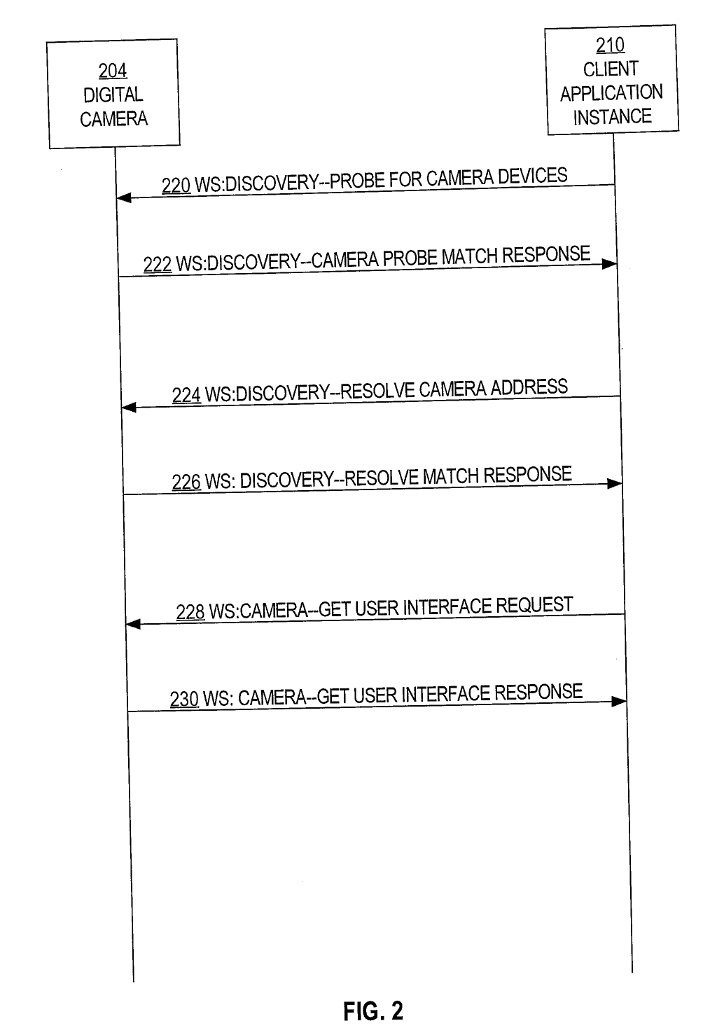

FIG. 2 is a diagram that illustrates an example of the sequence of message exchanges in which a client application and a digital camera may engage in order to communicate and generate an interactive visual depiction of that digital camera's user interface, according to an embodiment of the invention. Digital camera 204, which may be either one of digital cameras 104A-B illustrated in FIG. 1, communicates back and forth across network 108 with client application instance 210, which may be either one of client application instances 110A-B illustrated in FIG. 1. As is discussed above, in one embodiment of the invention, digital camera 204 and client application instance 210 communicate with each other by sending XML messages over network 108 in SOAP packets. Thus, digital camera 204 and client application 210 communicate with each other using web services technologies.

In step 220, client application instance 210 sends a web services discovery probe message toward all possible listeners, including digital camera 204; in one embodiment of the invention, client application instance 210 initially is unaware of the existence of any specific digital cameras with which client application instance 210 can communicate. The probe message seeks to discover, dynamically, the presence of digital cameras that are configured to send XML user interface descriptions to client application instance 210. The probe message may specify criteria that devices responding to the probe message need to satisfy (e.g., the probe message might require that responding devices be digital cameras that implement a specified schema). In one embodiment of the invention, the probe message conforms to the WS-Discovery web services specification. In one embodiment of the invention, client application instance 210 sends the probe message over network 108 as a multicast message that may be received by numerous other devices.

Although not expressly shown in FIG. 2, in one embodiment of the invention, prior to client application instance 210 sending the probe message as discussed above, digital camera 204 may send (e.g., via multicast on network 108) a WS-Discovery hello message that indicates various web services that digital camera 204 offers. Under such circumstances, client application instance 210 may receive the hello message and determine, from the content of that message, whether digital camera 204 offers a web service through which client application instance 210 can communicate, so that it becomes unnecessary for the probe message or the responsive probe match message (discussed below) to be exchanged.

However, assuming that client application instance 210 actually does send the probe message in step 220, then, in step 222, in response to receiving the web services discovery probe message, digital camera 204 replies to client application instance 210 with a web services discovery probe match response. This response identifies digital camera 204 (e.g., via a Uniform Resource Locator (“URL”) of digital camera 204) to client application instance 210, and informs client application instance 210 that digital camera 204 is configured to send an XML user interface description of the physical user interface of digital camera 204. In one embodiment of the invention, the response also identifies (e.g., via a URL) a specific schema (e.g., the schema described above with reference to Table 1) that digital camera 204 implements—typically, this schema will be the same schema that was specified in the criteria contained in the previous probe message to which the probe match message responds. Client application instance 210 may use the schema identifier to determine whether client application instance 210 implements the same schema and schema version as digital camera 204, and therefore, whether client application 210 is capable of generating a visual user interface for digital camera 204. In one embodiment of the invention, the probe match message, like the probe message, conforms to the WS-Discovery web services specification.

In one embodiment of the invention, client application instance 210 may receive several web services discovery probe match messages from several different devices; for example, referring back to system 100 shown in FIG. 1, client application instance 110A (which may correspond to client application instance 210 of FIG. 2) might receive separate probe match messages from both digital camera 104A and digital camera 104B. In one embodiment of the invention, if client application instance 210 receives multiple probe match messages from different devices, then client application instance 210 selects one device from among the particular device, and proceeds to communicate further with that device only. There are numerous different ways in which client application instance 210 might make this selection. In one embodiment of the invention, client application instance 210 displays, to a user, a list of responding digital cameras, along with information about each camera, such as each camera's location, purpose, and security capabilities (such information may be carried in the probe match response messages, for example). In such an embodiment of the invention, client application instance 210 receives, from the user, input that specifies a particular digital camera of the user's choosing.

Digital camera 204 may offer multiple different web services, each of which may be associated with a different TCP port number. Among the web services that digital camera 204 offers is the WS-Discovery web service, which is assigned a standard, well-known TCP port number; client application 210 sends web services discovery messages (such as the probe and probe match messages discussed above) to this TCP port. However, the WS-Camera web service, which is defined by the schema and from which client application instance 210 seeks to request further services, may operate on a TCP port of digital camera 204 whose number is not known beforehand to client application instance 210. Therefore, in step 224, client application instance 210 attempts to discover the TCP port number that is associated specifically with the WS-Camera web service of digital camera 204. Client application instance 210 does so by sending, to digital camera 204, a web services discovery resolve camera address message. This message asks digital camera 204 to tell client application instance 210 which TCP port number is associated with the digital camera's WS-Camera web service. In one embodiment of the invention, the web services discovery resolve camera address message conforms to the WS-Discovery web services specification.

In step 226, in response to receiving the resolve message sent in step 224, digital camera 204 generates and sends, back to client application instance 210, a web services discovery resolve match response message. This message identifies the TCP port number of the web service specified in the resolve message (specifically, in this case, the TCP port number of the digital camera's WS-Camera web service). In one embodiment of the invention, the web services discovery resolve match response message conforms to the WS-Discovery web services specification.

Thereafter, client application instance 210 sends camera-specific messages to digital camera 204 through the TCP port that is associated with the digital camera's WS-Camera web service. In step 228, client application instance 210 sends, to the WS-Camera web service of digital camera 204, a “GetUserInterfaceRequest” message, which takes the form of an XML document such as is shown by way of example in Table 2 above (the actual content of the message may differ from implementation to implementation). The message conforms to the schema that both client application instance 210 and digital camera 204 implement. The message asks digital camera 204 to send, to client application instance 210, a reply that contains a description of the physical user interface of digital camera 204.

In step 230, in response to receiving the “GetUserInterfaceRequest” message, the WS-Camera web service of digital camera 204 sends, to client application instance 210, a “GetUserInterfaceResponse” message, which takes the form of an XML document such as is shown by way of example in Table 3 above (the actual content of the message may differ from implementation to implementation). The message conforms to the schema that both client application instance 210 and digital camera 204 implement. The message contains a description of the physical user interface of digital camera 204.

After receiving the “GetUserInterfaceResponse” message from digital camera 204, client application instance 210 reads the user interface description specified within the message, generates a visual user interface based on the description, and displays the visual user interface to a user. In generating the visual user interface, client application instance 210 draws each control according to that control's characteristics and attributes (e.g., location, dimensions, shape, label, etc.) specified in that control's XML element. In one embodiment of the invention, the visual user interface that client application instance 210 draws is intentionally designed to have the same appearance as the physical user interface on digital camera 204 itself, so that a user who is familiar with the physical user interface will not have any difficulty understanding how to interact with the visual user interface.

As is discussed briefly above, as the user interacts with the visual user interface that client application instance 210 presents, client application 210 sends SOAP messages to the WS-Camera web service of digital camera 204. These messages conform to the implemented schema, and identify (potentially among other items of information) the identities of the controls with which the user interacted via the visual user interface. In one embodiment of the invention, these messages additionally identify the functions that digital camera 204 ought to perform in response to the user's interaction with those controls. Upon receiving the messages, digital camera 204 performs the functions that correspond to the virtual controls with which the user interacted.

Thus, a user is enabled to remotely control digital camera 204 from client application 210 using web services. For example, if the user mouse-clicks on a “ZoomIn” button in the visual user interface drawn by client application instance 210, then digital camera 204 may responsively cause its lens to zoom in on the subject that is currently in the lens' focus. For another example, a user's interaction with a “menu” control in the visual user interface may cause digital camera 204 to change states to an operational mode that corresponds to a particular menu item that the user selected via the virtual “menu” control. As digital camera 204 displays information and images in its LCD display (assuming that digital camera 204 has an LCD display), digital camera 204 may send, to client application instance 210, data that prompts client application instance 210 to draw, and instructs client application instance 210 how to draw, the same information and images in the virtual representation of that LCD display in the visual user interface.

### Example Serviced and Functions Provided by Digital Camera and Client Application

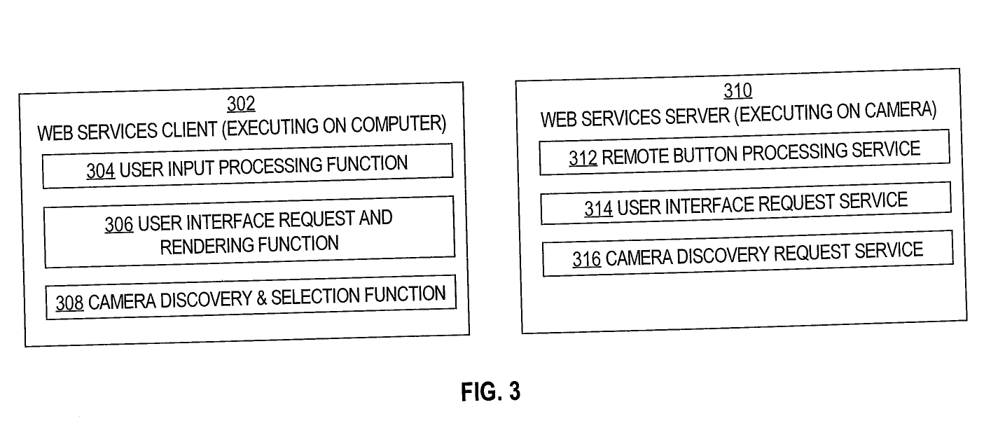

FIG. 3 is a block diagram that illustrates various functions provided by a web services client, which may execute on a computer, and various services provided by a web services server, which may execute on a digital camera, according to an embodiment of the invention. Web services client 302 includes a user input processing function 304, a user interface request and rendering function 306, and a camera discovery and selection function 308. Web services server 310 includes a remote button processing service 312, a user interface request service 314, and a camera discovery request service 316.

In one embodiment of the invention, user input processing function 304 receives user input from a user of the client application. Such input may describe the user's interactions with various virtual controls depicted in the visual user interface, for example. User input processing function 304 sends, to the digital camera, data that indicates which of the controls with which the user interacted. User interface request and rendering function 306 sends “GetUserInterfaceRequest” messages to the digital camera, receives corresponding “GetUserInterfaceResponse” messages from the digital camera, and generates and displays a visual user interface based on the user interface description contained in the messages received from the digital camera. Camera discovery and selection function 308 sends web services discovery probe messages and receives web services discovery probe match messages that allow the client application to discover compatible web service-offering digital cameras in a dynamic manner as described above. Camera discovery selection function 308 additionally comprises mechanisms for selecting a particular digital camera from among several compatible digital cameras that might be dynamically discovered, in the manner discussed above.

In one embodiment of the invention, remote button processing service 312 receives, from user input processing function 304, data that indicates which virtual controls with which the user interacted via the visual user interface. Remote button processing service 312 causes the digital camera to perform operations and functions (e.g., zoom in, zoom out, power on/off) that correspond to the virtual controls with which the user virtually interacted. User interface request service 314 receives “GetUserInterfaceRequest” messages from user interface request and rendering function 306, and responds with “GetUserInterfaceResponse” messages that describe the digital camera's physical user interface. Camera discovery request service 316 receives web service discovery probe messages from camera discovery and selection function 308, and responds with corresponding web service discovery probe match messages. Camera discovery request service 316 additionally or alternatively may send web service discovery hello messages.

Although embodiments of the invention are described above with specific reference to digital cameras, alternative embodiments of the invention may be applied to devices other than digital cameras. Thus, using techniques described herein, devices other than digital cameras may expose web services that provide descriptions of those devices' physical user interfaces. Such non-camera devices also may be controlled remotely from a client application instance that draws a virtual user interface based on descriptions obtained from those non-camera devices. For example, non-camera devices that might be remotely controlled using the techniques discussed above may include printers, scanners, copy machines, and multi-function peripherals (MFPs). Embodiments of the invention, though applicable to cameras, are not limited to any specific type of device.

### Implementation Mechanisms

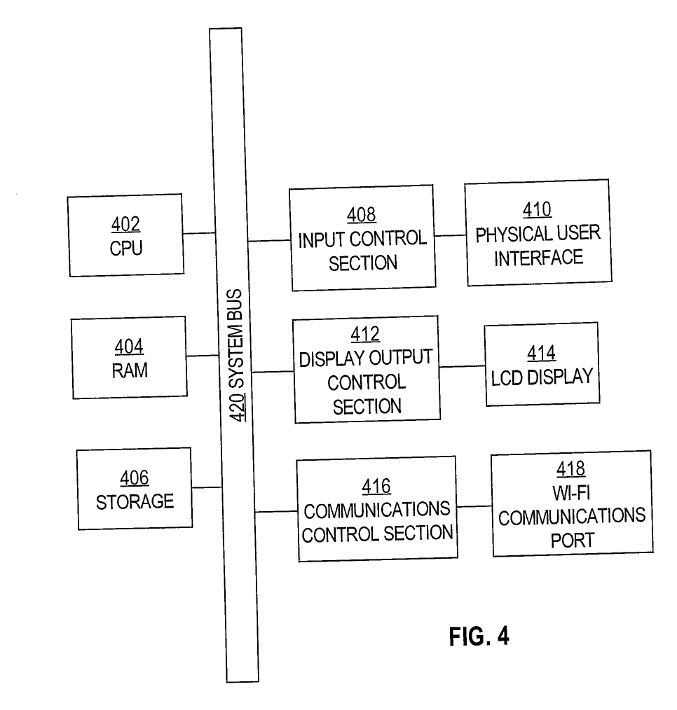

FIG. 4 is a block diagram that illustrates an example of the functional modules that are provided by the hardware of a digital camera, according to an embodiment of the invention. The digital camera includes a central processing unit (CPU) 402, a random access memory (RAM) 404, storage 406, input control section 408, physical user interface 410, display output control section 412, display 414, communications control section 416, Wi-Fi communications port 418, and system bus 420.

CPU 402 executes program code instructions, such as the instructions that form the web services server of the digital camera. In response to the execution of these instructions, CPU 402 sends signals, via system bus 420, to other components of the digital camera. RAM 404 receives, from bus 420, data that CPU 402 seeks to store in RAM 404, and sends, to bus 420, data that CPU 402 seeks to read from RAM 404. RAM 404 is an example of volatile memory. Storage 406, in contrast, is an example of persistent non-volatile memory. Storage 406 may be, for example, a magnetic hard disk drive, or a flash memory. Storage 406 retains its data contents even while the digital camera is not currently being electrically powered. Storage 406 receives, from bus 420, data that CPU 402 seeks to store in storage 406, and sends, to bus 420, data that CPU 402 seeks to read from storage 406.

Input control section 408 receives signals from physical user interface 410 and sends those signals via bus 420 to CPU 402. These signals indicate the physical controls of the digital camera with which the user has interacted. Physical user interface 410 comprises these physical controls, such as buttons, dials, etc. In one embodiment of the invention, physical user interface 410 is the user interface that the client application instance discussed above draws and simulates on a computer display.

Display output control section 412 receives signals from CPU 402 via bus 420 and causes LCD display 414 to display images and other information that is represented by those signals. In one embodiment of the invention, a representation of LCD display 414 is among the virtual components that are drawn in the visual user interface generated by the client application instance.

Communication control section 416 mediates communication between CPU 402 (via system bus 420) and Wi-Fi communications port 418. Wi-Fi communications port 418 receives wireless signals from sources external to the digital camera, and sends these signals to communication control section 416, which places the signals on bus 420 for CPU 402. CPU 402 sends (via system bus 420), to communication control section 416, signals that are destined for sources external to the digital camera. Communication control section 416 sends these signals to Wi-Fi communications port 418, which transmits the signals wirelessly to the specific external sources. These signals may include signals that represent SOAP packets that include XML documents which represent “GetUserInterfaceRequest” and “GetUserInterfaceResponse” messages, for example.

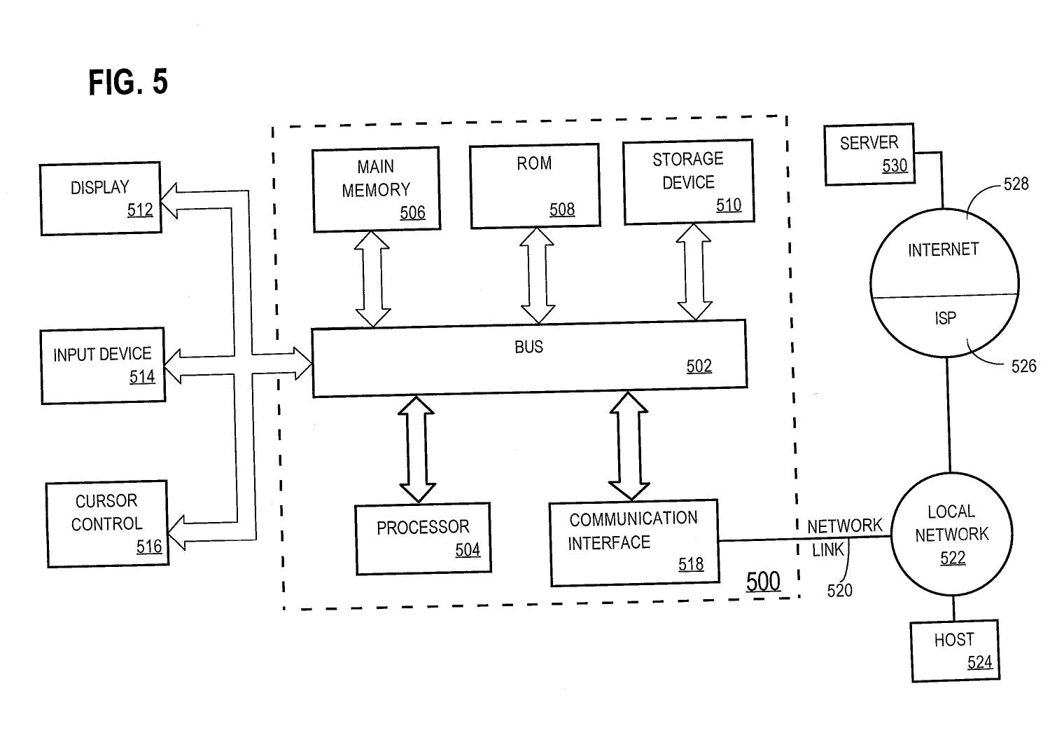

The approach described herein—and in particular, the client application—may be implemented on any type of computing platform or architecture. FIG. 5 is a block diagram that depicts an example computer system 500 upon which embodiments of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operation in a specific fashion. In an embodiment implemented using computer system 500, various computer-readable media are involved, for example, in providing instructions to processor 504 for execution. Such a medium may take many forms, including but not limited to, non-volatile media and volatile media. Non-volatile media includes, for example, optical or magnetic disks, such as storage device 510. Volatile media includes dynamic memory, such as main memory 506.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
receiving, from a first device, over a first communication link, a first description of a first physical user interface of said first device; and
based on said first description, generating a first visual depiction of said first physical user interface at a computer that is separate from said first device; and
displaying said first visual depiction on a display that is communicatively coupled to said computer.

2. The method of claim 1, further comprising:
receiving, from a second device that is a different model than said first device, over a second communication link, a second description of a second physical user interface of said second device; and
based on said second description, generating a second visual depiction of said second physical user interface at said computer; and
displaying said second visual depiction on said display;
wherein said generating of said first visual depiction and said generating of said second visual depiction are performed by a same client application instance.

3. The method of claim 1, wherein the first device is a digital camera.

4. The method of claim 1, wherein the first description is an Extensible Markup Language (XML) document.

5. The method of claim 1, wherein the step of receiving the first description comprises receiving the first description in one or more Simple Object Access Protocol (SOAP) packets.

6. A digital camera-implemented method comprising:
sending, from said digital camera, over a communication link, to a computer that is separate from the digital camera, a description of at least a portion of a physical user interface of said digital camera;
receiving, at said digital camera, over said communication link, from said computer, information that identifies a user interface control with which a user interacted via a visual user interface that said computer generated based on said description; and
performing an operation at said digital camera in response to receiving said information;
wherein said operation is an operation that said digital camera would have performed if said user had interacted with a physical control, corresponding to said user interface control, on a physical interface of said digital camera.

7. The method of claim 6, wherein said description defines locations and dimensions of two or more controls that are on said physical interface of said digital camera.

8. The method of claim 7, wherein said description specifies a different identifier of a plurality of identifiers for each control of said two or more controls, and wherein said information identifies a particular user interface control, with which said user interacted though said visual user interface, by a particular identifier of the plurality of identifiers.

9. The method of claim 6, wherein sending said description to said computer comprises sending an Extensible Markup Language (XML) document that conforms to a specified schema that defines types of physical user interface controls that are found on said physical interface.

10. A volatile or non-volatile computer-readable storage medium storing one or more sequences of instructions, wherein execution of the one or more sequences of instructions by one or more processors causes the one or more processors to perform the steps of:
receiving, from a first device, over a first communication link, a first description of a first physical user interface of said first device; and
based on said first description, generating a first visual depiction of said first physical user interface at a computer that is separate from said first device; and
displaying said first visual depiction on a display that is communicatively coupled to said computer.

11. The computer-readable medium of claim 10, wherein the steps further comprise:
receiving, from a second device that is a different model than said first device, over a second communication link, a second description of a second physical user interface of said second device; and
based on said second description, generating a second visual depiction of said second physical user interface at said computer; and
displaying said second visual depiction on said display;
wherein said generating of said first visual depiction and said generating of said second visual depiction are performed by a same client application instance.

12. The computer-readable medium of claim 10, wherein the first device is a digital camera.

13. The computer-readable medium of claim 10, wherein the first description is an Extensible Markup Language (XML) document.

14. The computer-readable medium of claim 10, wherein the step of receiving the first description comprises receiving the first description in one or more Simple Object Access Protocol (SOAP) packets.

15. A volatile or non-volatile computer-readable storage medium storing one or more sequences of instructions, wherein execution of the one or more sequences of instructions by one or more processors causes the one or more processors to perform the steps of:
sending, from a digital camera, over a communication link, to a computer that is separate from the digital camera, a description of at least a portion of a physical user interface of said digital camera;
receiving, at said digital camera, over said communication link, from said computer, information that identifies a user interface control with which a user interacted via a visual user interface that said computer generated based on said description; and
performing an operation at said digital camera in response to receiving said information;
wherein said operation is an operation that said digital camera would have performed if said user had interacted with a physical control, corresponding to said user interface control, on a physical interface of said digital camera.

16. The computer-readable medium of claim 15, wherein said description defines locations and dimensions of two or more controls that are on said physical interface of said digital camera.

17. The computer-readable medium of claim 16, wherein said description specifies a different identifier of a plurality of identifiers for each control of said two or more controls, and wherein said information identifies a particular user interface control, with which said user interacted though said visual user interface, by a particular identifier of the plurality of identifiers.

18. The computer-readable medium of claim 15, wherein sending said description to said computer comprises sending an Extensible Markup Language (XML) document that conforms to a specified schema that defines types of physical user interface controls that are found on said physical interface.
